(19) United States
(12) Patent Application Publication
(10) Pub. No.: US 2012/0030019 A1
(43) Pub. Date: Feb. 2, 2012

(54) Enablers For Service Delivery HUB On A Mobility Network

(76) Inventors: David Dunmire, San Antonio, TX (US); Chad C. Keith, San Antonio, TX (US); Clifford Marcus Owenby, San Antonio, TX (US)

(21) Appl. No.: 12/847,774

(22) Filed: Jul. 30, 2010

(51) Int. Cl. G06Q 30/00; G06F 15/173

(52) U.S. Cl. 705/14.53; 709/225; 705/14.49

(57) ABSTRACT

A system includes a hub server for providing a single point of access for an application and wherein the hub server also provides an access point for a user to access the application and wherein the application accesses one of a profile of the user, a location of the user, and an identity for the user and at least one enabler in communication with the hub server to provide additional functionality to the application based on the user's identity. The method includes querying a search enabler for search history of the user, identifying at least one of an identity of the user, a location of the user, and the profile of a user, creating an advertisement profile based on the search history to be retrieved and retrieving the advertisement based on the advertisement profile created.

### CROSS-REFERENCE TO RELATED APPLICATIONS

This application is related to U.S. application Ser. Nos. 12/720,217, 12/720,277, and 12/720,300, all filed on Mar. 9, 2010 and assigned to the assignee of this application, each of which is hereby incorporated by reference in its entirety. This application is also related to U.S. Patent Applications entitled “DYNAMIC STORAGE ENABLER FOR SERVICE DELIVERY HUB ON A MOBILITY NETWORK”, “METHOD FOR ENCRYPTING AND EMBEDDING INFORMATION IN A URL FOR CONTENT DELIVERY”, and “METHOD FOR AUTOMATING ONBOARDING OF USER GENERATED RINGBACK TONES TO SALES DISTRIBUTION CHANNEL” being filed concurrently herewith and assigned to the assignee of this application.

### TECHNICAL FIELD

This invention is directed to a service delivery platform, and more particularly, to a system, apparatus, and method for providing enabler services to third party application providers.

### BACKGROUND

In related application cited above, there was a disclosure that established an exemplary system and method for providing third party application service providers access to telecommunications services in order to exercise their respective business models. In that disclosure, there is disclosed a system and method in which a network operator may provide an environment for enabler providers to provide services to application service providers using the network operator's services and making such applications and services available to remote networks and users of those networks.

There is a need to expand the range of enabler services that are available to application service providers operating in a shared services environment.

### SUMMARY

The present disclosure includes a system including a hub server for providing a single point of access for an application and wherein the hub server also provides an access point for a user to access the application and wherein the application accesses one of a profile of the user, a location of the user, and an identity for the user, and at least one enabler in communication with the hub server to provide additional functionality to the application based on the user's identity. The at least one enabler may bean advertising enabler in communication with the hub server, wherein the application requests an advertisement from the advertising enabler based on one of the user's identity, the user's profile and the user's location. The system may also include a search enabler in communication with the hub server and wherein the advertising enabler uses data from the search enabler to determine advertising content to be presented to the user and may further include a recommendation enabler in communication with the hub server and wherein the advertising enabler uses data from the recommendation enabler and the search enabler to determine advertising content to be presented to the user. The system may also include a recommendation enabler in communication with the hub server and wherein the advertising enabler uses data from the recommendation enabler to determine advertising content to be presented to the user. The system may also include wherein the at least one enabler is a recommendation enabler in communication with the hub server, wherein the application accesses the recommendation enabler to suggest content to the user and wherein the recommendation is filtered based on the capabilities of a device used by the user or wherein the recommendations are filtered based on one of the location of the user, the profile of the user, and the identity of the user. The system may also include wherein the at least one enabler is a search enabler in communication with the hub server, wherein the application accesses the search enabler to provide the user access to search content across a plurality of networks and may further include a recommendation enabler in communication with the hub server, wherein the search results are filtered based on recommendations retrieved by the recommendation enabler or wherein the recommendations are based in part on one of the identity of the user, the profile of the user and the location of the user.

The disclosure may also include a method of providing an advertisement to a user, the method including querying a search enabler for search history of the user; identifying at least one of an identity of the user, a location of the user, and the profile of a user; creating an advertisement profile to be retrieved; and retrieving the advertisement based on the advertisement profile created. The method may also include wherein the advertisement profile is created also based on the identifying step. The method may also include providing a recommendation to the user wherein the recommendation is based on one of the search history of the user, the identity of the user, the location of the user and the profile of the user.

### BRIEF DESCRIPTION OF THE DRAWINGS

The following description is better understood when read in conjunction with the appended drawings, wherein

FIG. 1 is a system diagram of a service delivery hub in communication with remote networks;

FIG. 2 is a block diagram illustrating the functions of the service delivery hub and the interfaces open to third parties;

FIG. 3 is a block diagram illustrating the routing control function of the service delivery hub;

FIG. 4 is a block diagram illustrating the accessing of an enabler through the service delivery hub by a third party;

FIG. 5 is a block diagram illustrating an example of an architecture that illustrates the communications between an advertising enabler, a recommendation enabler, a search enabler and an ASP; and

FIG. 6 is an exemplary flow diagram that shows the process flow of an advertising enabler.

### DETAILED DESCRIPTION OF ILLUSTRATIVE EMBODIMENTS

For the purposes of describing an exemplary embodiment of the invention, reference will be made to the figures set forth above and certain terms. As an aid to the reader, exemplary definitions of such terms are defined as follows:
“Application service provider (ASP)” is a provider which has one or more applications which employ the services of the service delivery hub.
“Aggregator” has relationships to one or more ASPs or developers and manages the access of the ASPs' respective applications to the service delivery hub.
“Enabler provider (EP)” develops services which may be incorporated into other applications, for example, a message enabler provider may provide access to WAP push, SMSC, and MMSC services as set forth below.
“On device” applications are applications that are downloadable to a device such as a mobile handset or smart phone.
“Web-hosted based” applications are applications which are sold in a subscription based model and accessed by customer devices.

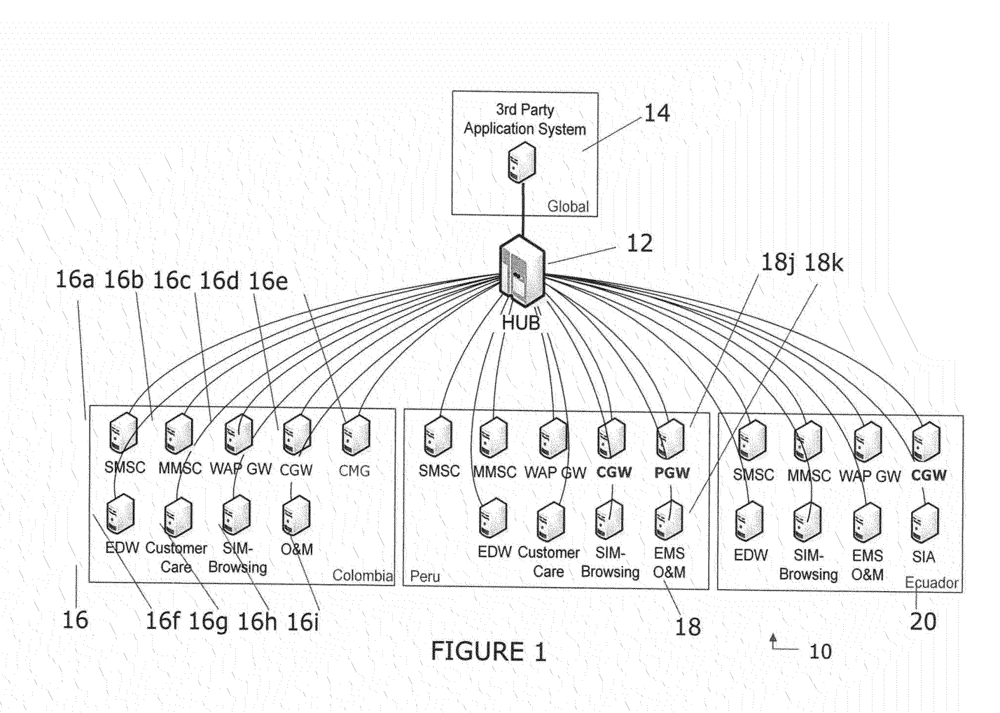

With reference to FIG. 1, there is shown a system 10 having a service delivery hub 12 in communication with network operations 16, 18, and 20. As described more fully herein, the service delivery hub 12 provides a central access point for third party ASPs, aggregators, and enabler providers and includes a set of application programming interfaces (API) provided by the network provider or other third parties. The service delivery hub 12 also includes a charging gateway which provides the capability for third parties to monetize their applications and a settlement center which balances accounts of multiple parties and network operators in accordance with contractual fee splitting arrangements or other mechanisms determined by the parties, so-called recursive settlements. The service delivery hub 12 also includes a control center to manage access to the system.

Referring again to FIG. 1, there is shown a third party application server 14 in communication with the service delivery hub 12. The service delivery hub 12 is targeted to produce an integration layer for access to the network operations 16, 18, and 20, specifically network elements, operational support systems and business support systems (OSS/BSS), and Internet application service providers (ASPs). The network operations 16, 18, and 20 (also referred to as networks herein) are illustrative only and could vary in number from one to many networks. The networks may be stand alone networks in a particular geographic area, which areas may be delineated on a country or state basis or any other geographic distinction. The networks may also be delineated by network operator or network type. There may also be more than one network in any one geographic region.

In the exemplary embodiment of FIG. 1, network operations 16 are designated as being in the country of Columbia, network operations 18 in Peru, and network operations 20 in Ecuador. Within each network operations 16, 18, 20, there is shown a representative sample of network subsystems contained therein and, in the case of network operations 16 in Columbia, shown numbered as 16a-16i. Those subsystems within network operations 16 include the short message service center (SMSC) 16a, multi-media service center (MMSC) 16b, wireless access protocol (WAP) gateway 16c, CGW 16d, CMG 16e, enterprise data warehouse (EDW) 16f, customer care 16g, subscriber interface module (SIM) browsing 16h, and operations and maintenance (O&M) 16i. It will be understood by those skilled in the art that not all subsystems are necessarily found in each network operations 16, 18, 20 and there may be other subsystems not listed above, for example, PGW 18j, and emergency management systems (EMS) 18k are illustrated as part of network operation 18 but not as part of network operation 16.

The service delivery hub 12 exposes access to third party applications to network services provided by the network subsystems. The service delivery hub 12 supports third party developed services and controls application usage of network operations and third party services. It is preferred that the service delivery hub employ industry standards known to those skilled in the art or to be developed by the industry, including but not limited to Parlay X, SOAP, REST, HTTPS, JKD 1.5, XML, SSL+X509 certification for transport security, and WSSE username token profile security.

The service delivery hub 12, has interfaces into each of the subsystems within network operations 16, 18, 20. An exemplary methodology for using those interfaces may include establishing a VPN tunnel from the service delivery hub 12 to the subsystem of interest. Thus, if an application residing on the third party application system server 14 desires access to SMSC 16a, the service delivery hub 12 will establish a VPN tunnel or other connection to SMSC 16a thereby providing the application access to SMSC 16a.

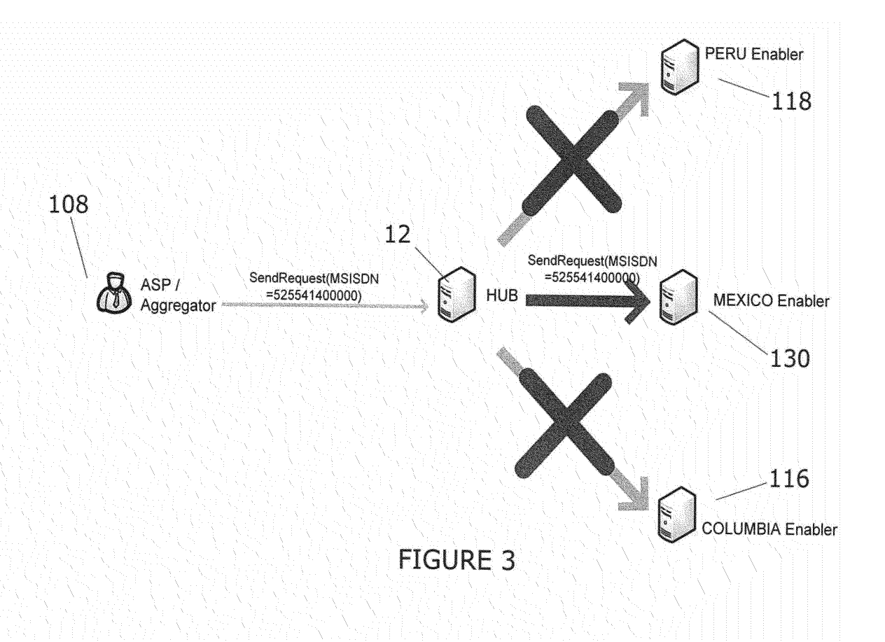

An example of this routing is shown in FIG. 3. In that example, an aggregator 108 is utilizing the service delivery hub 12 to access an enabler 130 located in Mexico through an API provided by enabler 130 and made available to aggregator 108 through service delivery hub 12. The aggregator will send a request message to the service delivery hub 12 which includes an identifier, in this case, a MSISDN. The service delivery hub 12 will interpret the MSISDN and determine that it is destined for enabler 130 located in Mexico and not for the enablers 116 and 118 located in Columbia and Peru, respectively. The service delivery hub 12 then establishes a VPN tunnel to the enabler 130 located in Mexico and will prevent access to other networks. This limited but direct access may be monetized by the enabler and the network operator.

The service delivery hub 12 operates based on a series of service level agreements (SLAs) between various parties and the network operator. The service delivery platform 12 encapsulates access to the network enablers, OSS/BSS enablers, application service provider (ASP) enablers and ASP applications. The service delivery platform 12 provides an application service creation gateway which provides standard APIs and software development kits (SDKs) to third party application providers. The service delivery hub 12 provides management functions for partners and aggregators, such as authentication, hosting, SLA policy control, service routing, limited charging, messaging, usage billing, settlement, monitoring, and reporting.

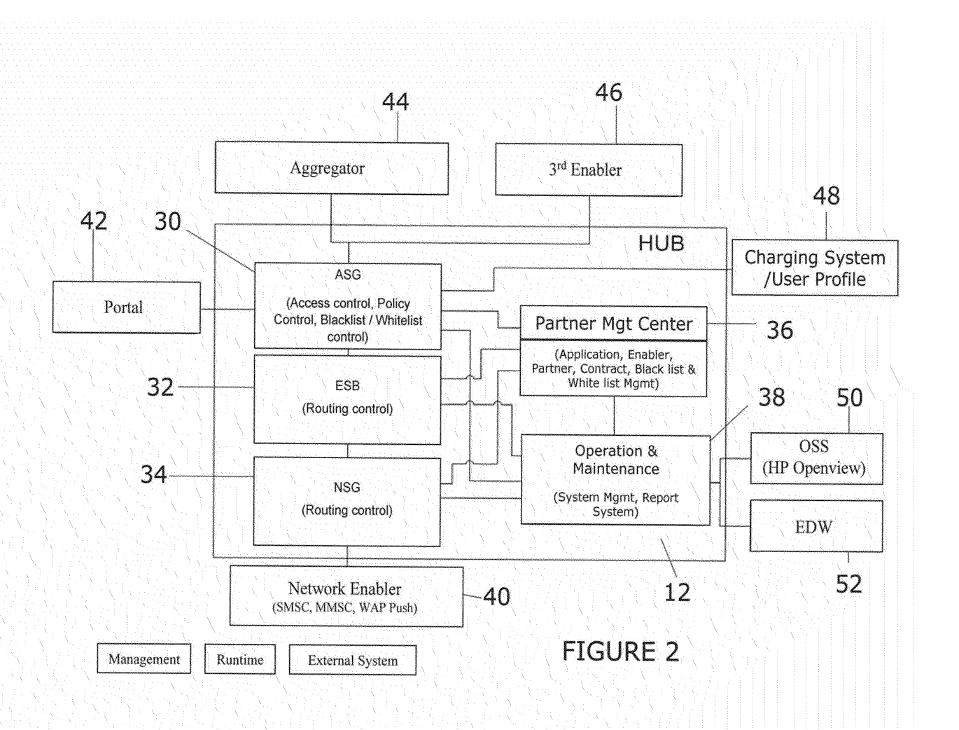

With reference to FIG. 2, an exemplary service delivery hub includes 12 functionality such as ASG 30, enterprise service bus (ESB) 32, network service gateway (NSG) 34, business manager (BLM) 36, and Operation & Maintenance 38. ASG 30 provides access control, policy control, and blacklist/whitelist control.

Portal 42 provides an external link which uses the ASG 30 functionality to control access to the service delivery hub and further to authenticate users. The portal function 42 of the service delivery hub 12 provides for the sales and distribution of content, including third party applications. Specific functionality may include device management and rendering, a recommendation engine, detailed application descriptions, product categorization, multi-language support, sales and revenue settlement reports, advertising associations and multi-network footprint.

The SRS/User Profile Server 48, shown in an exemplary embodiment as outside of service delivery hub 12 but interfacing therewith, provides storage media for user information and profiles and is accessible by the ASG function 30. Additional access and control interfaces are provided within the ASG function 30 for access by aggregators 44 and third party enablers 46.

The access control function within ASG 30 provides services such as service provider and user authentication and verification. The service level policy control function enables the service delivery hub 12 to control and, if necessary, limit the system resources available to an third party application to prevent system overloading. By controlling the system resources through the service delivery hub, the network resources are able to be allocated along a broad range of applications. Policy control also provides for monetization at the service level or the parameter level for access to all network enablers. The scarcity of or availability of resources depending on time of day and loading algorithms provide variable and cost effective price strategies to third party developers and enablers. Quality of service and pricing associated therewith may also be provided by the policy control function.

Routing control functionality is provided by enterprise service bus (ESB) 32. This includes developing or configuring the routing policy. The routing control functionality of the service delivery hub 12 enables the third party providers to interface with the network or multiple networks at one and only one access point. The service delivery hub 12 is preferably able to interpret the MSISDN to determine the local network operator involved in the transaction and route accordingly. For example, the ESB 32 may route based on MSISDN in a GSM environment. The routing may also be determined based on location, including country or market, or a sales portal catalog.

The network services gateway (NSG) 34 within the service delivery hub 12 interfaces with network enablers 40 to provide access to network functionality, including, for example, SMSC 16a, MMSC 16b, or WAP GW 16c or any other network elements or systems.

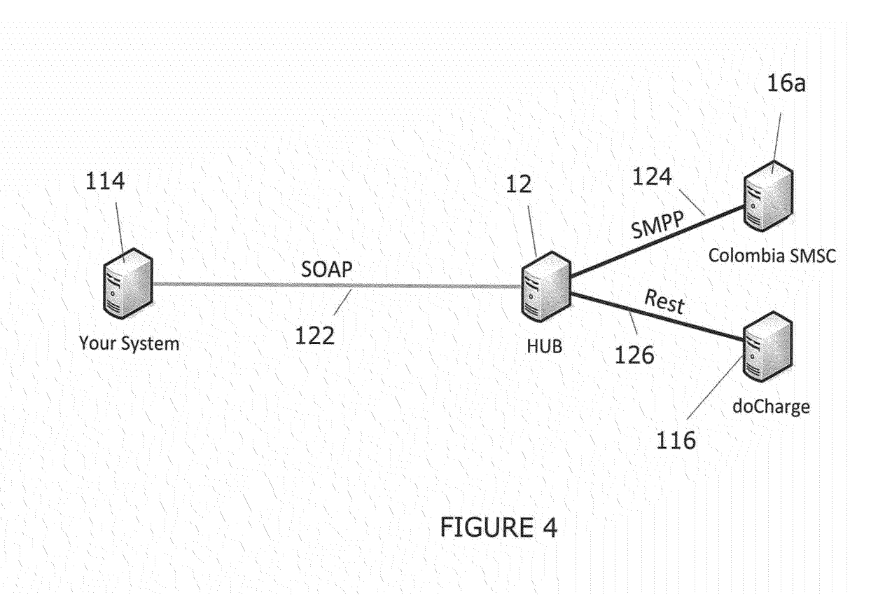

The service delivery hub 12 includes business management functions 36 which include the contracting capability between the network operators and the enabler providers and the network operators and the ASPs. The business management functions 36 include the ability to interface to a charging module, for example, the doCharge subsystem 116 in FIG. 4. In that example, a third party 114 may access the service delivery platform 12 using the SOAP protocol interface 122 to access the SMSC subsystem 16a located in Columbia under contract. The service delivery platform 12 will access the doCharge subsystem 116 for charging and reconciling the cost of such access to the third party (or its customers). From a third party's development standpoint, the third party system 114 will receive an API for the desired enabler, in this example, the SMSC 16a in Columbia. The third party would then develop the program using the API on the third party system 114 and test the program using the service delivery hub 12 test environment. Once development is completed, the third party system 114 will complete its purchase of access to the enabler and cut over to the production version of the service delivery hub 12.

Referring again to FIG. 2, the operations and maintenance functionality 38 of the service delivery hub 12 includes system management and reporting functions and provides interfaces to the operational support systems (OSS) 50 and electronic data warehouses (EDW) 52. The settlement functionality within the operations and maintenance functions 38 of the service delivery hub 12 provides allocation of revenue and reports covering various aspects of sales. This may include asset sales such as applications or enabler usage. Report features may include multi-currency and multi-country settlements. Moreover, there may be recursive settlement functionality for multi-party transactions. The reporting functionality within the operations and maintenance functions 38 of the service delivery hub 12 may be customized for a variety of applications and enablers. For example, reports may include application service provider settlements, application service provider traffic, enabler provider settlement, enabler provider traffic, traffic TPS reports, error, availability and sales portal reports.

The service delivery hub 12 provides the added functionality of monetization of third party applications and services. For example, the network enablers are provided the tools to be able to charge at the parameter level for access to all network enablers. Using the access control and other policy rules, third party enablers are able to throttle or gate applications based on TPS or total volume, time of day and other parameters. Moreover, the network operators may apply quality of service to the network-based APIs and third party supplied APIs.

With respect to third party enablers, the network operator may pay or revenue share for the use of such enablers. The network operator may sell access to the third party enablers. Finally, the network operator may recursively charge and settle with third party enablers.

In operation, the ASP may enter into a contractual relationship with a mobile network operator through which contract the network operator will provide functionality and interfaces using a set of SLA's to the ASP. The ASP incorporates the functionality into the application. The application is then either sold on the network operator's portal 42 (or multiple portals located in different geographic areas) or sold directly to the ASP.

Continuing with an operational view, an enabler, either a third party network enabler or a third party application enabler, may also enter into a contractual relationship with the mobile network operator. The enabler may provide a set of interfaces to the service delivery hub 12 on a revenue share basis to be used by third party ASPs using the service delivery hub 12.

There are many examples of this monetization business model. For example, application service providers utilizing the service delivery hub may contain products or services offered to the ASP's customers and include contractual terms with the network operator through which the network operator and the ASP both share in the monetization of an application. For example, video game developers may offer a gaming system to its customers on a storefront accessible through the portal 42 of the service delivery platform. The game may include, for example, a free trial version downloadable to a mobile device with an option to purchase the full version. The network operator will receive the order from the customer, deliver the full version of the game to the customer, receive payment from the customer, and then share the revenue generated with the ASP.

According to another exemplary utilization of the invention, an enabler may provide messaging services through an API that is made available to the ASP developing a video gaming application. For example, the enabler may offer two products to the ASP for a gaming application, sending and receiving SMS messages and sending and receiving MMS messages which permit users of the game to text or video chat while playing the game. For each, the ASP may charge its customers either a flat fee or a use-based fee or build the fee into the cost of the game. The network operator will bill and collect for the game from the customer. The network operator may charge the ASP a set-up fee, a maintenance fee, or a service-level based fee for use or a flat-rate fee for use, then pay the enabler a portion thereof for the use of the SMSC and MMSC subsystems, and then provide the remainder of the revenue from the customer to the ASP.

In another exemplary embodiment, an enabler may provide a service to the network operator on behalf of third party ASPs. For example, the enabler may provide mobile advertising services, including getting advertisements, posting advertisements and tracking advertisements. Depending on the contractual relationships, the parties involved in the transaction may share the advertising revenue either two ways, i.e., the enabler and network provider, or three ways, including the ASP.

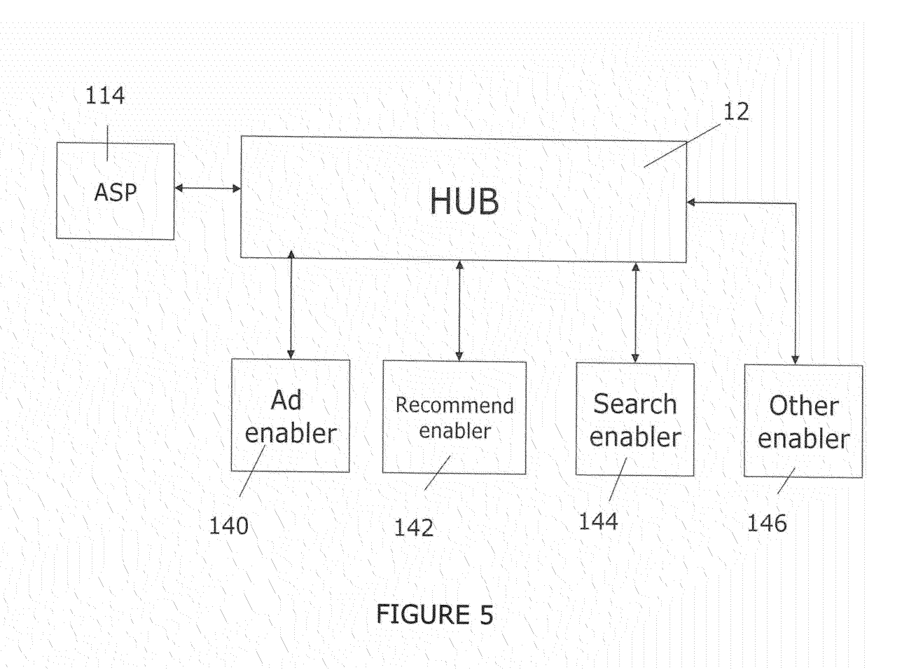

For example, the present disclosure includes three additional enablers, namely an advertising enabler, a search enabler and a recommendation enabler. With reference to FIG. 5, there is shown an exemplary block diagram showing the hub 12, an application service provider 114, an advertising enabler 140, a recommendation enabler 142 and a search enabler 144. There is also shown a block representing other enablers 146 which may be present in a system. The enablers may be co-located within the hub 12 or located external to the hub 12.

The advertising enabler's 140 purpose is to provide a means by which third party application service providers 114 may register their application ad spaces with a network operator's advertising server in order to garner highly-targeted and relevant advertisements to place within their applications. Specifically, network operators may have the systems to serve ads to web pages, WAP pages, messages, and internal applications. In addition network operators may have more knowledge of the customer tp which the ad is targeted through its own account and profile systems. This enabler exposes an ability to register ad spaces with key words within those spaces, which in turn the network operator's ad and customer account management systems will use to serve advertisements. The advertising enabler also exposes a means to track “click-throughs” in order to charge the advertiser for the advertisement. The advertising enabler provides settlement services for the 3rd party in order to track how much the 3rd party should be paid for exposing advertisements in the application. The advertising enabler may support all advertising rate models including cost per action, cost per click, cost per thousand impressions and click through rate.

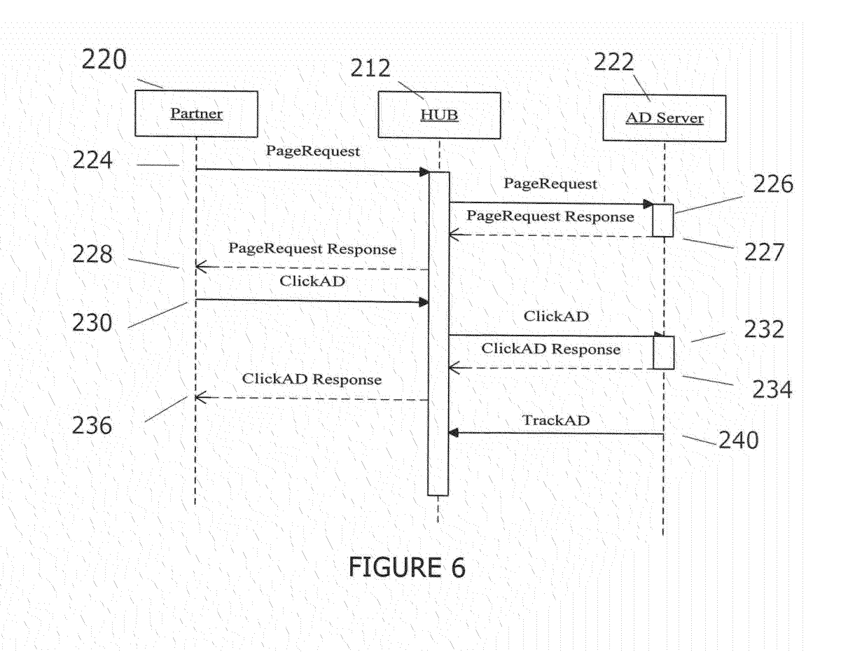

FIG. 6 illustrates an exemplary process flow for the advertising enabler which may be provided by a network operator. In this case, the partner 220 communicates with a hub advertising enabler 212 and an advertisement server 222. The partner 220 may represent a third party application provider. At step 224, the partner sends advertisement request to request advertisement content. At step 226, the hub Advertising Enabler 212 sends the advertisement request to the advertisement server 222 to retrieve content for the advertisement. At step 227, the ad server provides a response of the advertisement request back to the hub advertising enabler 212. At step 228, the hub advertising enabler 212 forwards that response to the partner 220. When an end user clicks the advertisement in the partner's application, the partner application will send the click request to hub advertising enabler at step 230. The hub advertising enabler 212 sends the click request to advertisement server 222 at step 232. At step 234, the advertisement server provides a response to the advertisement click back to the hub advertising enabler 212 which in turn forwards that response to the partner application. At step 236. Finally, at step 240, the advertisement server 222 will provide log files periodically to the hub advertising enabler 212 which will provide the data for settlement between the network operator, the advertiser, and the third party application.

APIs may be provided to an application service provider to access the hub advertisement enabler 212. The following may be provided in an API:

PageRequest—The PageRequest API allows an Application to request an advertisement. The API contains an identifier which may represent the application's advertising space. This identifier may be used by the advertisement server 222 to determine the type of advertisement to place into the return for this request. For example, the identifier for the advertisement space may specify that a text advertisement be deployed within an SMS message. Alternatively, the identifier may specify that a banner advertisement be deployed with a MMS, WAP page, Web Page, immersive environment (i.e., game) or Wap Push. Additionally, the identifier may specify that a multimedia advertisement be deployed on a MMS, WAP page, Web Page, immersive environment (i.e., game), or Wap Push. The API may also collects a set of keywords associated with the context of the application which accesses the page request API. The hub advertisement enabler 212 uses these keywords, along with the customer's profile and account information, to determine and to present advertisements that are relevant to the context of the experience being presented to the user through the application. The PageRequest API may return the advertisement in the specified format or in multiple formats to the application for use in the application. The advertisement may contain a URL which when clicked passes back through the hub advertisement enabler 112 in order to be tracked for settlement calculations.

TrackAd—The TrackAD API allows an advertisement management system which may be located in the advertisement server 222 to provide a report of the number of impressions and click-throughs as well as the price paid for each of such click-throughs back to the hub advertisement enabler 212. The hub advertisement enabler may use the information for each transaction in order to provide settlement services to provide a revenue share between the advertiser, the network operator and the third party application provider.

ClickAd—The ClickAD API allows an application to register a click-thru of a placed advertisement by the application's user. This may be handled via a proxy URL attached to the advertisement itself which may be generated automatically. The proxy then records the user and usage of the advertisement for later processing by the settlement service.

SendAd—The SendAD API may be used by an application service provider in order to generate a message for a customer with an advertisement attached to the message.

Messages may be generated in either SMS, MMS, USSD, or Wap Push formats. The advertisement attached to the message may also include a proxy URL described above for Click-thru tracking purposes. Each message may be built by the application service provider and enables the ASP to determine where, within the message, to place an advertisement. This may be done, for example, using Message Text Template Tags. Those tags are depicted in the following Table 1:

TABLE 1
Message Text Template Tag Definitions

| Parameter | Required? | Description |
|---|---|---|
| ${Partner Name} | N | ${Partner Name} is a partner's company |
| | | name. The partner is who calls this API. |
| ${NO MIB URL} | N | ${NO MIB URL} is the network operator's |
| | | respective portal MIB proxy. It is country based. |
| ${Partner URL} | N | ${Partner URL} is a partner URL. The partner |
| | | is who calls this API. |
| ${NO Name} | N | ${NO Name} is a network operator name. |
| ${NO URL} | N | ${NO URL} is a network operator URL. |
| ${Partner Logo} | N | ${Partner Logo} is a partner's company Logo |
| | | The partner is who calls this API. |
| ${Advertisement} | N | is a request to have the HUB populate this |
| | | section of the message with an Advertisement. |
| | | This should only be allowed when a MSISDN |
| | | is available |
| ${Distribution Name} | N | is the Name assigned to the person matched to |
| | | the distribution list message. i.e. Mr. George S. Patton |
| ${Distribution List | N | is the Name assigned to the list itself i.e. |
| Name} | | Astronomy Club Members |
| ${Customer Type} | N | is the customer type information from the |
| | | Customer Profile. This should only be allowed |
| | | when a MSISDN is available |
| ${image_src_link} | N | This is customer.img element value from the |
| | | “page request” response. |
| | | This is optional if the MsgType is SMS or |
| | | Wap Push. |
| | | Note: If there are multi-value of |
| | | image_src_link, Hub only needs to use the the |
| | | first element value. |
| ${ad_text} | Y | This is customer.ad_text element value from |
| | | the “page request” response. |
| | | Note: If there are multi-value of ad_text, Hub |
| | | only needs to use the first element value. |
| ${links} | Y | This is links element value from the “page |
| | | request” response. |
| | | Note: If there are multi-value of links, Hub |
| | | only needs to use the first element value. |

An example of use of the message template is shown below:

Continuing with the example architecture in FIG. 5, there is shown a recommendation enabler 142 (also referred to as a recommender enabler herein). The recommendation enabler may be configured within the hub 12 (not shown) or external to the hub 12 as shown. The hub recommender enabler's 142 purpose is to provide a means by which third party application service providers may acquire information regarding content items relevant in context to a consumer's interest. When the ASP supplies a MSISDN, the recommendation enabler may access the recommendation function and then apply the results of recommendation to the results of the inquiry. To determine the results of the inquiry, the recommendation enabler 142 accesses the customer's registered interest, past purchases, and past browsing behavior. The recommendation enabler 142 then ranks the interests accordingly, and produces a list of suggested content, including browse sites based upon this data and relevant to the context of the inquiry.

In operation, the recommendation enabler 142 will receive an API call for getting the relevant recommendations using the supplied parameters, which may, for example, be the identification of the user requesting recommendations, the identification of the item currently being viewed, recommender specification, language, device, or any other parameters. Using these parameters, the recommendation enabler 142 will process the recommendations and return recommendations to the calling application which will render the final content to the user. The recommendations may, for example, be embedded in the returned XML. The identification of the input device may be used to format or to limit the list of suggested content to be compatible with that device.

The hub recommender enabler 142 may also supply the ability for third party APSs to collect consumer feedback about content, browse sites and products in a manner such that this information may be added to the information available for future recommendations, either for the present user or other users. Users or subscribers may provide feedback on content/products through interaction with the internal network operator's portal as well as with the ASP's applications supplying feedback. The recommender enabler 142 may receive an API call for storing the relevant recommendation feedback using the supplied parameters. Such parameters may, for example, include the identification of the user supplying the recommendation feedback, item(s) receiving recommendation feedback, a transaction identifier, a location, a category or any other relevant parameter.

Device filtering of recommendable items may be part of the feature set supplied by the hub recommender enabler 142. This eliminates the need to process content pieces for consumers which the consumer can not use. The actual device agent is used to filter out recommendations that are not accepted by that device The hub recommendations enabler 142 also has the ability to provide default recommendations when a consumer's profile is not yet available to the system. In this case the recommendation may be based upon contextual metadata, participation in a user community, contextual community, or a list of top-rated or most popular. APIs to call the hub recommender enabler 12 may include programs directed to GetRecommendation, GetRecommendationforCommunity, or ProvideFeedback.

Continuing with the description of FIG. 5, there is also shown a hub search enabler 144. The hub search enabler 144 may be co-located within the hub 12 (not shown) or external to the hub 12 as shown. The hub search enabler 144 provides the ASPs with an ability to provide consumers with a search service regarding the content available to a mobile consumer. This is called a federated search as it provides a means to search multiple content databases, and the internet itself. The search enabler 144 may be used independently by as ASP or in conjunction with the recommendation enabler 142. When a MSISDN is included, then the hub search enabler 144 may also be able to include a consumer's location and profile in order to supplement the search results with more contextual information regarding the consumer. Using keywords across all of these data sources along with the consumer profile information and the content itself, the search enabler 144 may provide recommendations to a consumer based on preconfigured criteria. The hub search enabler 144 may expose an interface to enable searching of multiple mobile content sources. The hub search enabler 144 may also allow restricting the returned results based upon a consumer's current location, keywords, format type (including text and/or pictures, as well as restricting access to various content databases based on the application itself. The hub search enabler 144 may also allow retrieval of consumer generated content related to the keywords inputted on the search which may or may not be part of the hub recommender enabler 142.

The hub search enabler 144 may also be used in conjunction with the hub advertising enabler 140. The hub search enabler 144 may utilize keywords, consumer profiles and location to provide an advertisement to the search results. T

In operation, the search enabler 144 may format search results into multiple sections such as the search results, recommendations, and advertisements. The search results may include mobile content filtered based upon device type or other criteria, user generated content, or the internet.

While the enablers within the service delivery hub have been described in connection with the various embodiments of the various figures, it is to be understood that other similar embodiments can be used or modifications and additions can be made to the described embodiment for performing the same types of functionality in service delivery without deviating therefrom. While the enablers have been described for use in an exemplary hub environment, other environments are contemplated, including self-contained networks. Any type of telecommunications network may be supported, including but not limited to GSM, CDMA, EDGE, 3G, 4G, LTE or any other wireless network and may also interface and provide access to wired networks, including the internet. Therefore, the hub enablers should not be limited to any single embodiment, but rather should be construed in breadth and scope in accordance with the appended claims.

What is claimed:

1. A system comprising:
a hub server for providing a single point of access for an application and wherein the hub server also provides an access point for a user to access the application and wherein the application accesses one of a profile of the user, a location of the user, and an identity for the user; and
at least one enabler in communication with the hub server to provide additional functionality to the application based on the user's identity.

2. The system of claim 1 wherein the at least one enabler is an advertising enabler in communication with the hub server, wherein the application requests an advertisement from the advertising enabler based on one of the user's identity, the user's profile and the user's location.

3. The system of claim 2 further comprising a search enabler in communication with the hub server and wherein the advertising enabler uses data from the search enabler to determine advertising content to be presented to the user.

4. The system of claim 3 further comprising a recommendation enabler in communication with the hub server and wherein the advertising enabler uses data from the recommendation enabler and the search enabler to determine advertising content to be presented to the user.

5. The system of claim 2 further comprising a recommendation enabler in communication with the hub server and wherein the advertising enabler uses data from the recommendation enabler to determine advertising content to be presented to the user.

6. The system of claim 1 further wherein the at least one enabler is a recommendation enabler in communication with the hub server, wherein the application accesses the recommendation enabler to suggest content to the user.

7. The system of claim 6 wherein the recommendation is filtered based on the capabilities of a device used by the user.

8. The system of claim 6 wherein the recommendations are filtered based on one of the location of the user, the profile of the user, and the identity of the user.

9. The system of claim 1 wherein the at least one enabler is a search enabler in communication with the hub server, wherein the application accesses the search enabler to provide the user access to search content across a plurality of networks.

10. The system of claim 9 further comprising a recommendation enabler in communication with the hub server, wherein the search results are filtered based on recommendations retrieved by the recommendation enabler.

11. The system of claim 9 wherein the recommendations are based in part on one of the identity of the user, the profile of the user and the location of the user.

12. A method of providing an advertisement to a user, comprising:
querying a search enabler for search history of the user;
identifying at least one of an identity of the user, a location of the user, and the profile of a user;
creating an advertisement profile based on the search history to be retrieved; and
retrieving the advertisement based on the advertisement profile created.

13. The method of claim 12 wherein the advertisement profile is created also based on the identifying step.

14. The method of claim 12 further comprising providing a recommendation to the user.

15. The method of claim 14 wherein the recommendation is based on one of the search history of the user, the identity of the user, the location of the user and the profile of the user.
